(19) United States
(12) Patent Application Publication
(10) Pub. No.: US 2022/0402301 A1
(43) Pub. Date: Dec. 22, 2022

(54) NON-PNEUMATIC TIRE AND RIM ASSEMBLY

(71) Applicant: The Goodyear Tire & Rubber Company, Akron, OH (US)

(72) Inventors: Nathan Edward Yensho, Akron, OH (US); Wesley Glenn Sigler, Barberton, OH (US); Ann Elizabeth Myers, Cuyahoga Falls, OH (US); Arun Kumar Byatarayanapura Gopala, Copley, OH (US); Md Atiqur Rahman Bhuiyan, Copley, OH (US); Andrew James Miller, Akron, OH (US)

(21) Appl. No.: 17/660,029

(22) Filed: Apr. 21, 2022

Related U.S. Application Data
(60) Provisional application No. 63/211,235, filed on Jun. 16, 2021.

(51) Int. Cl. B60C 7/14; B60B 25/00; B60B 1/06; B60B 5/02

(52) U.S. Cl. CPC B60C 7/146; B60B 25/002; B60B 1/06; B60B 5/02; B60B 2360/10; B60B 2360/32

(57) ABSTRACT

A non-pneumatic tire and wheel assembly which includes a rim, and a spoke ring structure having an inner ring that is mounted on an outer surface of the rim. The inner ring has one or more retention nubs aligned for reception in complementary shaped grooves on the outer surface of the rim, wherein the spoke ring structure has a plurality of spoke members, and an outer tread ring is mounted on the outer circumference of the spoke ring.

### FIELD OF THE INVENTION

The invention relates in general to a vehicle wheel, and more particularly to a non-pneumatic tire and rim assembly.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominate today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non-pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus, an improved non-pneumatic tire is desired that has all the features of the pneumatic tires without the drawback of the need for air inflation is desired. It is also desired to have an improved non-pneumatic tire that has longer tread life as compared to a pneumatic tire of the same size.

### SUMMARY OF THE INVENTION

The invention provides in a first aspect a non-pneumatic tire and wheel assembly comprising: a rim, a spoke ring structure having an inner ring that is mounted on an outer surface of the rim, wherein the inner ring has one or more retention nubs aligned for reception in complementary shaped grooves on the outer surface of the rim, wherein the spoke ring structure has a plurality of spoke members, and an outer tread ring mounted on the outer circumference of the spoke ring.

### Definitions

“Aspect Ratio” means the ratio of a tire's section height to its section width.

“Axial” and “axially” means the lines or directions that are parallel to the axis of rotation of the tire.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Radial” and “radially” mean directions radially toward or away from the axis of rotation of the tire.

### BRIEF DESCRIPTION OF THE DRAWINGS

The invention will be described by way of example and with reference to the accompanying drawings in which:

FIG. 1 is a front view of a non-pneumatic tire and rim assembly of the present invention;

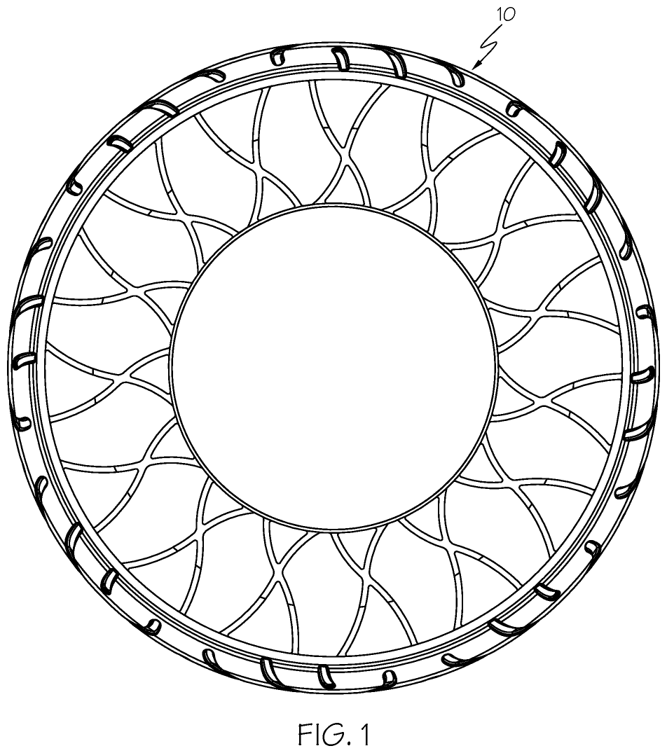

FIG. 2 is a side view of the non-pneumatic tire and rim assembly of FIG. 1;

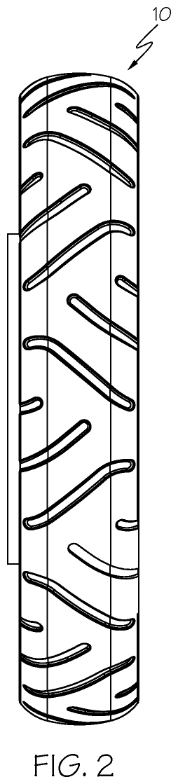

FIG. 3 is a rear view of the non-pneumatic tire and rim assembly of FIG. 1;

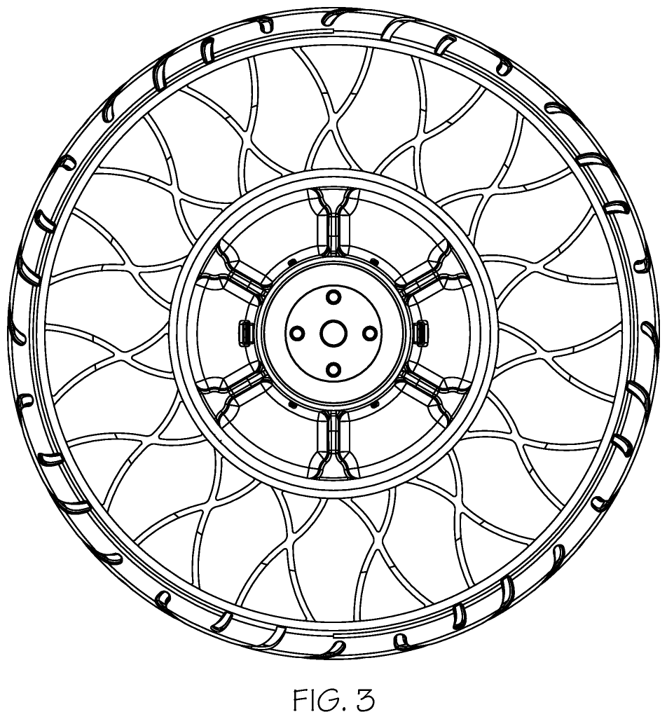

FIG. 4 is a perspective view of the non-pneumatic tire and rim assembly of FIG. 1;

FIG. 5 is an exploded view of the non-pneumatic tire and rim assembly of FIG. 1;

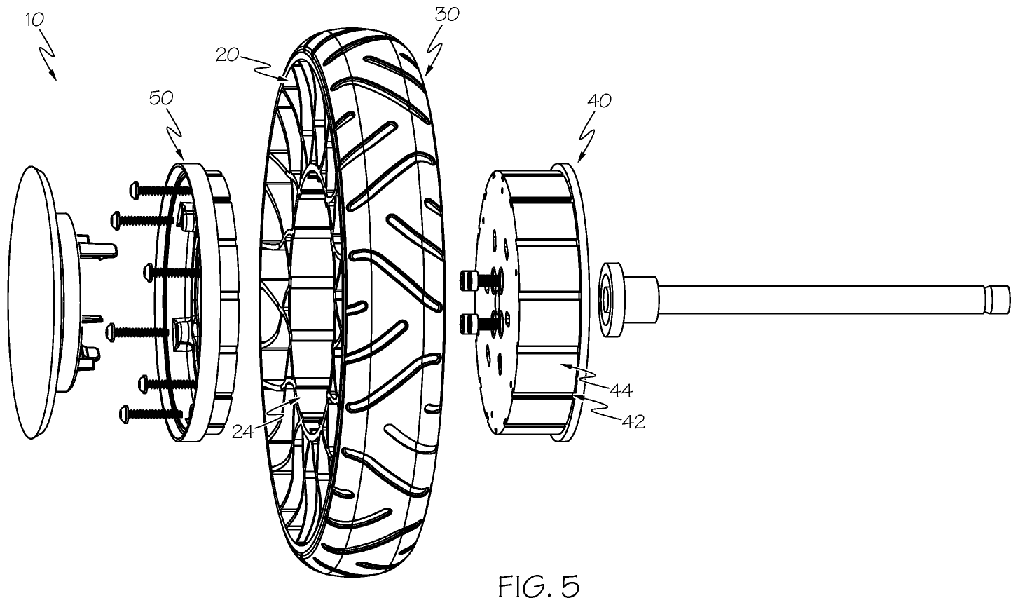

FIG. 6 is an exploded cross-sectional view of the non-pneumatic tire and rim assembly of FIG. 1;

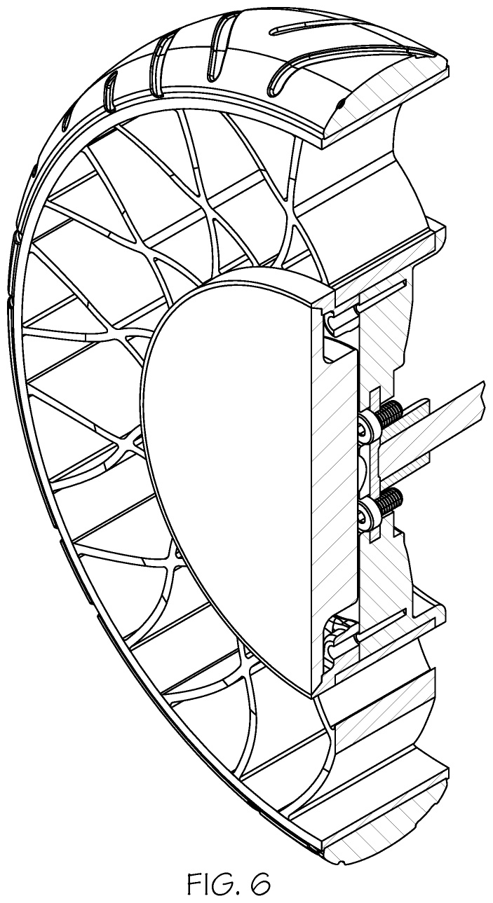

FIG. 7 is a perspective front view of the outer rim of the split rim assembly;

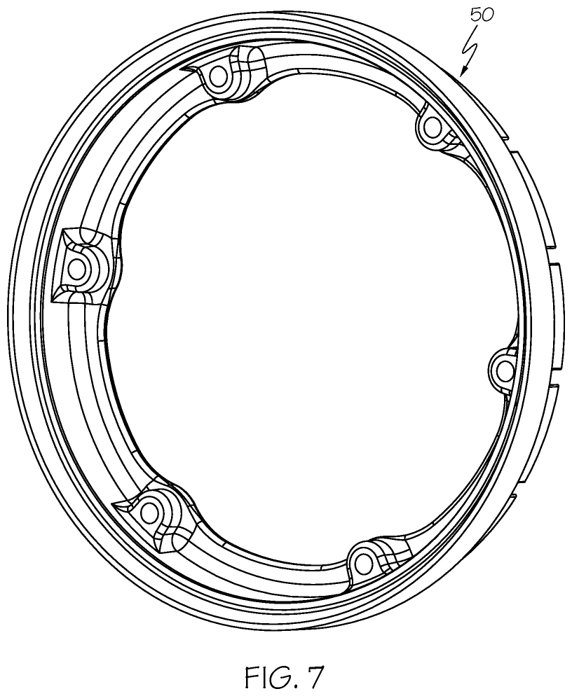

FIG. 8 is a perspective rear view of the outer rim of the split rim assembly;

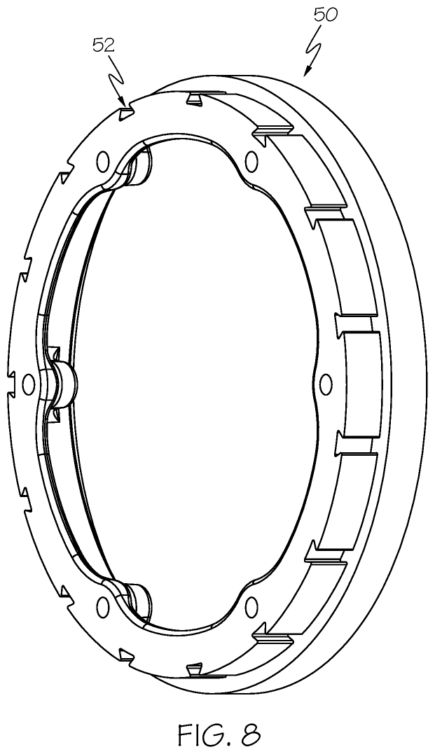

FIG. 9 is a side view of the outer rim of the split rim assembly;

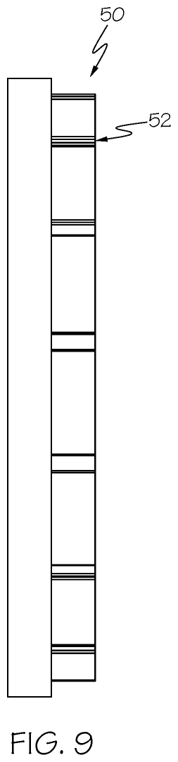

FIG. 10 is a side view of inner rim of the split rim assembly;

FIG. 11 is a rear view of the inner rim of the split rim assembly;

FIG. 12 is side cross-sectional view of the inner rim of the split rim assembly;

FIG. 13 is a perspective rear view of the inner rim of the split rim assembly;

FIG. 14 is a perspective view of the metal disc;

FIG. 15 is a front view of the spoke ring structure; and

FIG. 16 is a perspective view of a micromobility vehicle with non-pneumatic tires of the present invention.

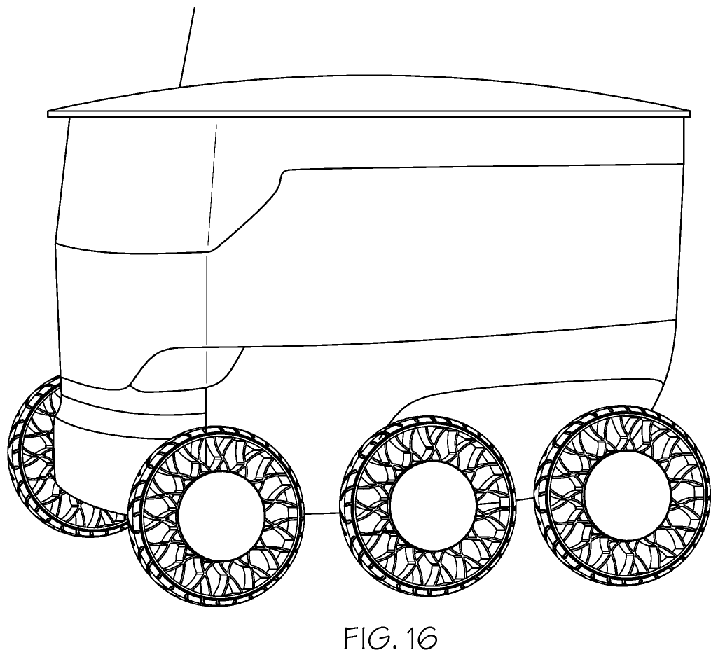

### DETAILED DESCRIPTION OF THE INVENTION

Referring to the Figures, a non-pneumatic tire and rim assembly 10 of the present invention is shown. The non-pneumatic tire and rim assembly 10 includes an outer annular tread ring 30, a spoke ring structure 20, and a split rim assembly formed of an inner rim 40 mounted to a spindle, and an outer rim 50. The outer annular tread ring 30 is preferably a one piece annular structure that is formed of a polymer, rubber or other desired elastomer. The tread ring 30 may be molded and cured as a one piece ring, and is mounted on the outer periphery of the spoke ring. The outer tread ring 30 is preferably removable from the outer spoke ring for replacement. The outer surface of the tread ring 30 may include tread elements such as ribs, blocks, lugs, grooves, and sipes as desired in order to improve the performance of the tire in various conditions.

The tread ring 30 may further include one or more reinforcement layers, wherein the reinforcement layers comprise a plurality of parallel reinforcement cords. The reinforcement cords may be angled in the range of −40 to +40 degrees with respect to the circumferential direction. Preferably, there are two reinforcement layers, with the first reinforcement layer angled in the range of 0 to 20 degrees, and the second reinforcement layer oriented at the same angle in the opposite direction, i.e., in the range of 0 to −20 degrees. An optional shear layer may be located between the two reinforcement layers.

### Spoke Ring Structure

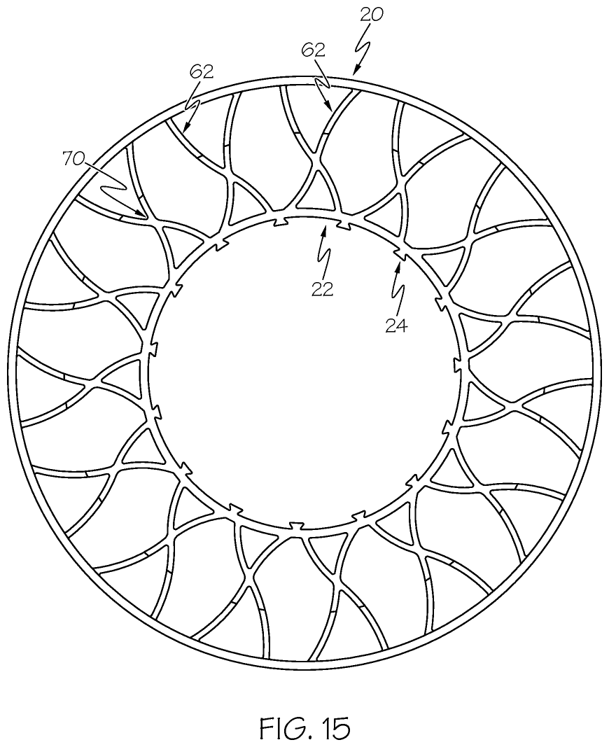

The non-pneumatic tire and rim assembly 10 further includes a spoke ring structure 20. The spoke ring structure 20 has an inner ring 22 that is mounted on the inner rim 40 of the split rim assembly 60. The spoke ring structure 20 has an axial width approximately the same axial width of the nonpneumatic tire assembly 10. The inner ring 22 has a plurality of retaining nubs or projections 24, as shown in FIG. 15. In this example, the nubs 24 have sidewalls which are preferably non-parallel. The nubs 20 are preferably polygonal or triangular in cross-sectional shape. However, the nubs 24 may be any desired shape, and extend in the axial direction preferably the full axial width of the spoke ring structure. To removably mount the spoke structure, the retaining nubs 24 of the inner spoke ring are aligned and mounted in complementary shaped grooves 42 of the inner rim 40.

The spoke ring structure further includes an outer ring 26 having an outer surface that is joined to the inner tread surface 32 by an adhesive polymer. The spoke ring structure further includes a plurality of spoke members that extend between the inner ring 22 to the outer ring 26. As shown in FIG. 15, the spoke ring structure has a first spoke member 60 that extends from the inner ring 22 to the outer ring 26 at an angle. The spoke ring structure includes a second spoke member 62 that also extends from the inner ring to the outer ring 26 at an angle. The first and second spoke member 60,62 are joined together at a junction 70 to form an X shaped spoke. The first and second spoke members 60,62 may be straight or curved.

The spoke ring structure 20 is preferably an integrally formed annular structure made of a resilient elastomeric material or moldable polymeric material such as natural rubber, styrene butadiene rubber, polybutadiene rubber or EPDM rubber or a blend of two or more of these rubbers which can be utilized in either injection molding or compression molding. The spoke ring structure 20 has an axial thickness equal to the axial thickness of the non-pneumatic tire. The spoke ring structure 20 has a plurality of spokes that connect an inner ring 22 and an outer ring 24.

The spoke disks are preferably formed of an elastic material, more preferably, a thermoplastic elastomer. The material of the spoke disks is selected based upon one or more of the following material properties. The tensile (Young's) modulus of the spoke disk material is preferably in the range of 15 MPa to 100 MPa.

### RIM

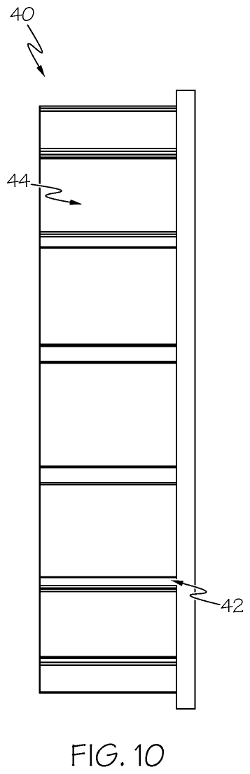

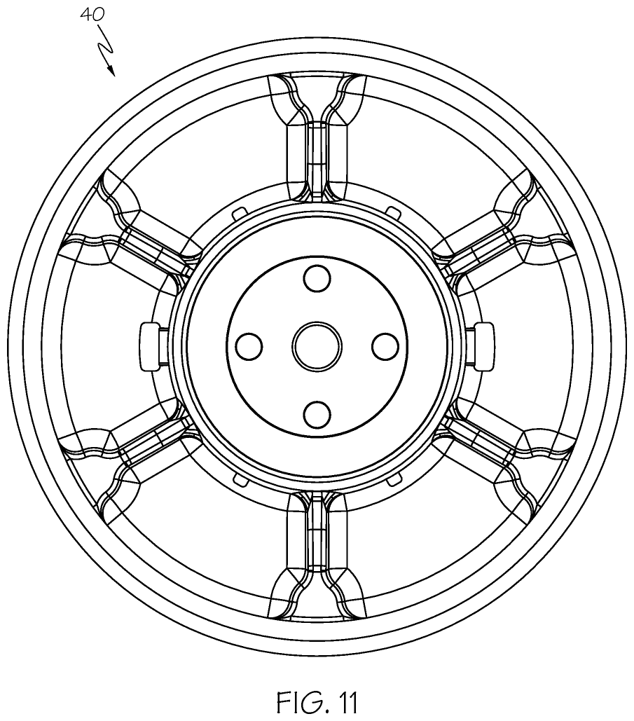

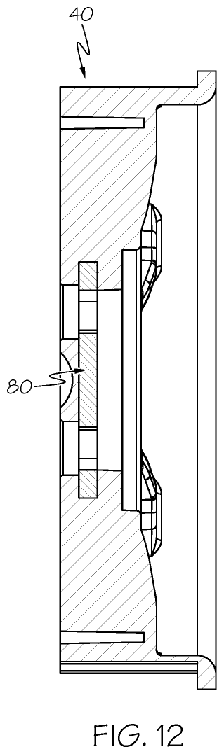

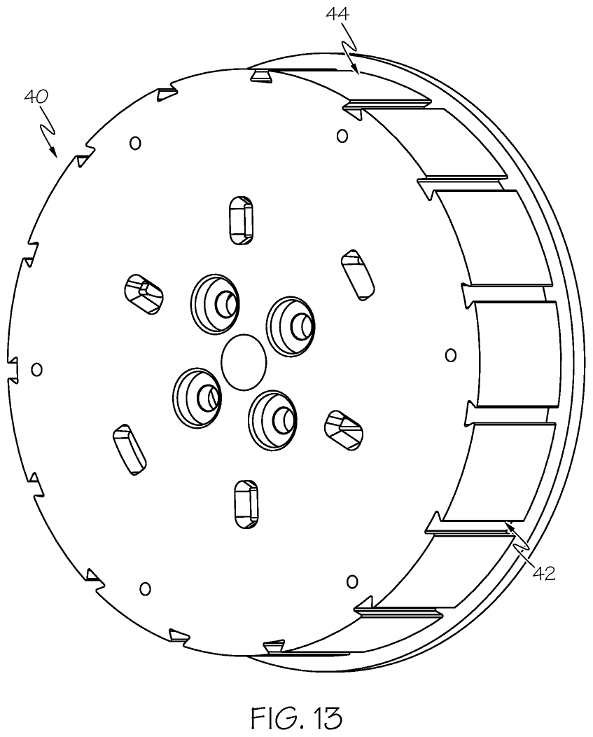

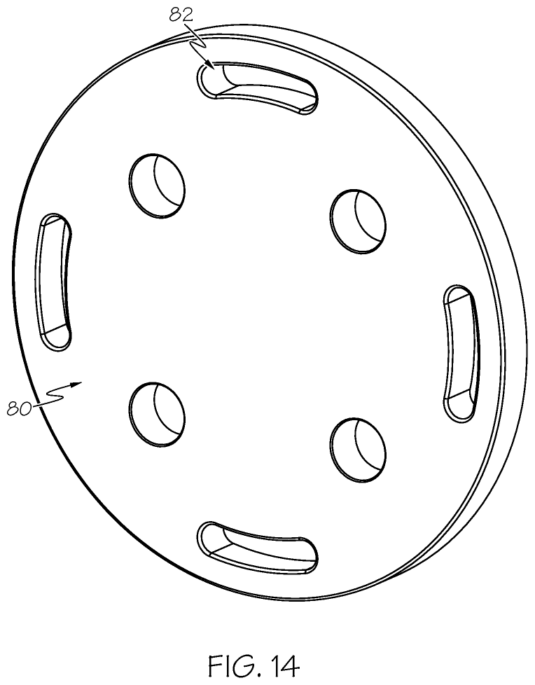

The split rim assembly is formed of an inner rim 40 that is mounted to the vehicle spindle by fasteners. The rim 40 has a tire supporting outer circumferential surface with mating grooves 42. The spoke structure is then removably mounted on the inner rim so that the nubs are aligned and received in the mating grooves of the inner rim 40. The inner rim is shown in FIGS. 10-13. The inner rim has a metal disk 80 shown in FIG. 14 which is molded internal to the inner rim by an overmolding process. In the overmolding process, the metal disk is inserted inside the mold used to form the inner rim, and then the material is injection molded around the metal disk. The metal disk reinforces the plastic rim to prevent cracking. The metal disk includes one or more slots 82 located on the metal disk which help secure the disk within the rim due to the injection molding of the plastic which will be received within the slots to form an interlock. The rim 40 is preferably of a substantially rigid material such as a rigid plastic with glass fiber reinforcement. In one example, the rim material may be nylon 6,6.

The split rim assembly further includes an outer rim 50. The outer rim 50 has an outer surface having a plurality of complementary shaped grooves 52 that mate with the nubs of the spoke disk structure. The outer rim 50 secures to the inner rim 40 via fasteners.

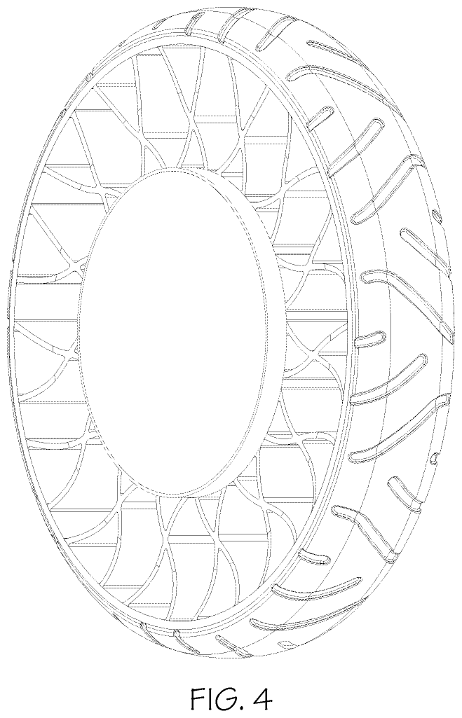

In one example, the tire of the present invention is provided on a mobile delivery vehicle 100 as shown in FIG. 4. The mobile delivery vehicle 100 has at least three, preferably four or more non-pneumatic tire and rim assemblies of the present invention, and more particularly, six non-pneumatic tire and rim assemblies. The tire has an outer rubber tread and a spoke ring structure that is injection molded and formed of a thermoplastic or polyurethane material having a tensile modulus of about 10-100 MPA. The spoke ring structure may also be three dimensionally printed. The non-pneumatic tire and rim of the present invention has a spring rate in the range of 250 to 300 pounds per inch. The non-pneumatic tire and rim of the present invention has an axial width of about 1.5 inches with 15-24 X shaped spokes having a radial height in the range of about 1 to 2 inches. While the non-pneumatic tire and wheel assembly is described as having X shaped spokes, other spoke designs could be used. The rim has an outer diameter of about 5 inches, but could be sized to be smaller in the outer diameter to provide a greater radial height of the spoke ring structure. The weight of the tire is about 500 grams and is designed for a tread life of about 20,000 mile range.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire and wheel assembly comprising: an inner rim and an outer rim, a spoke ring structure having an inner ring that is mounted on an outer surface of the inner rim, wherein the inner ring has one or more retention nubs aligned for reception in complementary shaped grooves located on the outer surface of the inner rim, wherein the spoke ring structure has a plurality of spoke members, and an outer tread ring mounted on the outer circumference of the spoke ring.

2. The non-pneumatic tire and wheel assembly of claim 1 wherein the retention nubs are polygonal in cross-section.

3. The non-pneumatic tire and wheel assembly of claim 1 wherein the retention nubs are triangular in cross-section.

4. The non-pneumatic tire and wheel assembly of claim 1 wherein the spoke ring structure is removable mounted on the inner rim.

5. The non-pneumatic tire and wheel assembly of claim 1 wherein the nonpneumatic tire is removable mounted on the inner rim without requiring disassembly of the nonpneumatic tire.

6. The non-pneumatic tire and wheel assembly of claim 1 wherein the spoke members of the spoke ring structure are joined together at a junction to form an X shaped spoke.

7. The non-pneumatic tire and wheel assembly of claim 1 wherein the outer rim includes a plurality of mating grooves for reception of the retaining nubs.

8. The non-pneumatic tire and wheel assembly of claim 5 wherein the shear ring is located between the tread ring and the spoke ring structure.

9. The non-pneumatic tire and wheel assembly of claim 1 wherein the non-pneumatic tire and wheel assembly is formed by three dimensional printing.

10. The non-pneumatic tire and wheel assembly of claim 1 wherein the spoke ring structure is formed of a polymer material having a tensile modulus in the range of 15 to 100 mpa.

11. A non-pneumatic tire and wheel assembly comprising: an inner rim and an outer rim, a spoke ring structure having an inner ring that is mounted on an outer surface of the inner rim, wherein the spoke ring structure has a plurality of spoke members, and an outer tread ring mounted on the outer circumference of the spoke ring.

12. The non-pneumatic tire and wheel assembly of claim 11 wherein the inner rim further includes a metal disk located inside the inner rim.

13. The non-pneumatic tire and wheel assembly of claim 11 wherein the metal disk is overmolded inside the inner rim.

14. The non-pneumatic tire and wheel assembly of claim 1 wherein the spoke ring structure is formed of a thermoplastic or polyurethane material.
